(19) United States
(12) Patent Application Publication
(10) Pub. No.: US 2025/0186845 A1
(43) Pub. Date: Jun. 12, 2025

(54) PICKLEBALL RACKET

(71) Applicant: Shuyi ZENG, Heyuan (CN)

(72) Inventors: Shuyi ZENG, Heyuan (CN); Weicheng ZENG, Heyuan (CN)

(73) Assignee: Shuyi ZENG, Heyuan (CN)

(21) Appl. No.: 18/423,080

(22) Filed: Jan. 25, 2024

(30) Foreign Application Priority Data
Dec. 6, 2023 (CN) 2023233197138
Dec. 6, 2023 (CN) 2023233197157

(51) Int. Cl. A63B 59/45; A63B 60/08; A63B 60/54; B32B 3/12; B32B 5/02; B32B 5/26; B32B 7/022; B32B 15/06; B32B 21/04; B32B 25/08; B32B 27/08; B32B 27/12; B32B 27/30; B32B 27/32

(52) U.S. Cl. CPC A63B 59/45; A63B 60/08; A63B 60/54; B32B 3/12; B32B 5/02; B32B 5/26; B32B 7/022; B32B 15/06; B32B 21/045; B32B 25/08; B32B 27/08; B32B 27/12; B32B 27/306; B32B 27/32; A63B 2209/02; B32B 2250/05; B32B 2250/40; B32B 2262/101; B32B 2262/106; B32B 2307/536; B32B 2307/7376

(57) ABSTRACT

The present application relates to a pickleball racket. The pickleball racket includes a racket main body and a handle. The handle is connected to one side of the racket main body. The racket main body includes a carbon fiber layer, a glass fiber layer, an EVA layer and a PP honeycomb layer, which are arranged in a stacked manner. The PP honeycomb layer has a honeycomb slot structure. In this embodiment, due to high strength and rigidity of a carbon fiber material, the carbon fiber layer can be provided to improve the stability and durability of the racket. The pickleball racket in the present application can absorb and reduce the vibration and impact generated in the event of collision of the racket with a ball, thereby greatly reducing the noise, and also reducing a force on the hand, and improving a shock-absorbing effect of the racket.

### CROSS-REFERENCE TO RELATED APPLICATIONS

The application claims priority to Chinese patent application No. 2023233197157, filed on Dec. 6, 2023 and No. 2023233197138, filed on Dec. 6, 2023, the entire contents of which are incorporated herein by reference.

### TECHNICAL FIELD

The present application relates to the technical field of sporting goods, and more particularly to a pickleball racket.

### BACKGROUND

Pickleball is a sport in which a racket hits a ball, which rises from Bainbridge Island in Seattle, USA, and is a mixed sport of tennis, badminton and table tennis. The pickleball has become a regular sport event in a middle school PE course and has become increasingly common among young and old.

In general, the pickleball racket is made of a wooden board or carbon fiber or glass fiber. The pickleball racket made of the wooden board is manifested by bad experience for athletes or users because of heavy weight, poor handfeel, large hardness, poor shock-absorbing effect and large noise. Therefore, to provide a pickleball racket with good grip feel, good shock-absorbing effect, low noise and light weight is a technical problem that needs to be solved at present.

### SUMMARY

An embodiment of the present application provides a pickleball racket, in order to solve the problems of large hardness, heavy weight and large noise.

In a first aspect, an embodiment of the present application relates to a pickleball racket. The pickleball racket includes a racket main body and a handle, wherein the handle is connected to one side of the racket main body; the racket main body includes a carbon fiber layer, a glass fiber layer, an EVA layer and a PP honeycomb layer, which are arranged in a stacked manner; and the PP honeycomb layer has a honeycomb slot structure. In this embodiment, due to high strength and rigidity of a carbon fiber material, the carbon fiber layer can be provided to improve the stability and durability of the racket. A glass fiber material has good elasticity and toughness, so the glass fiber layer is used to increase the elasticity and strength of the racket, and can absorb and disperse an impact force generated in the course of hitting a ball, reduce the degree of vibration transmission to the hand, and improve a shock-absorbing effect of the racket. An EVA material has a good buffering performance, so the EVA layer is used to improve a buffering effect and shock resistance of the racket, and can absorb and reduce the vibration and impact generated in the event of collision of the racket with the ball, thereby greatly reducing the noise, and also reducing a force on the hand, and improving a shock-absorbing effect of the racket. The PP honeycomb layer is a key component of the racket main body. The design of the honeycomb slot structure of the PP honeycomb layer can also reduce the weight of the racket, making the racket lighter and easier to control. Therefore, the pickleball racket in this embodiment has a better shock-absorbing effect, greatly reduced noise, and light weight, and is easy to control.

In some embodiments, the carbon fiber layer includes a first carbon fiber layer and a second carbon fiber layer, the glass fiber layer includes a first glass fiber layer and a second glass fiber layer, and the EVA layer includes a first EVA layer and a second EVA layer; and the first carbon fiber layer, the first glass fiber layer, the first EVA layer, the PP honeycomb layer, the second EVA layer, the second glass fiber layer and the second carbon fiber layer are successively arranged in a stacked manner. In this embodiment, the first carbon fiber layer, the first glass fiber layer, the first EVA layer, the PP honeycomb layer, the second EVA layer, the second glass fiber layer and the second carbon fiber layer are successively arranged in a stacked manner, which can effectively take effects of the respective layers, and can obtain a better hitting effect.

In some embodiments, the pickleball racket further includes a third EVA layer, wherein the third EVA layer is located between the first EVA layer and the PP honeycomb layer, and the thickness of the third EVA layer is less than that of the first EVA layer. In this embodiment, since the pickleball racket further includes the third EVA layer, and the first EVA layer and the third EVA layer are attached together, an assembly gap between the first EVA layer and the third EVA layer can play a better buffering role, so as to further effectively reduce the resulting noise. In addition, the third EVA layer is less thick and thinner than the first EVA layer, which can reduce the noise generated in the course of hitting the ball. When the racket collides with the ball, the first EVA layer can absorb and buffer the vibration, while the thinner third EVA layer can restore its shape more quickly, and reduce the duration and intensity of the vibration, thereby reducing the generation of noise.

In some embodiments, the hardness of the first EVA layer is different from that of the third EVA layer. In this embodiment, since the hardness of the first EVA layer is different from that of the third EVA layer, a better shock-absorbing effect can be obtained to effectively reduce the noise.

In some embodiments, the thickness of the PP honeycomb layer is greater than a sum of the thickness of the first EVA layer and the thickness of the third EVA layer. In this embodiment, since the thickness of the PP honeycomb layer is greater than the sum of the thickness of the first EVA layer and the thickness of the third EVA layer, the elasticity to the ball can be guaranteed to be within a required range, without being affected by the EVA layers.

In some embodiments, the pickleball racket further includes a fourth EVA layer, wherein the fourth EVA layer is located between the second EVA layer and the PP honeycomb layer, and the thickness of the fourth EVA layer is less than that of the second EVA layer. The fourth EVA layer can be provided to further reduce the noise, i.e., reduce the noise in the course of hitting with a back surface.

In some embodiments, the hardness and thickness of the fourth EVA layer are consistent with those of the third EVA layer. The fourth EVA layer is provided such that both hitting with the front surface and hitting with the back surface of the pickleball racket can effectively reduce the noise and improve the user's experience.

In some embodiments, the thickness of the PP honeycomb layer is greater than a sum of the thickness of the first EVA layer, the thickness of the second EVA layer, the thickness of the third EVA layer, and the thickness of the fourth EVA layer. Since the thickness of the PP honeycomb layer is greater than the sum of the thicknesses of all the EVA layers, the elasticity to the ball can be guaranteed to be within a required range, without being affected by the EVA layers.

In some embodiments, the pickleball racket further includes a first rubber layer and a second rubber layer; the first rubber layer is located between the first EVA layer and the PP honeycomb layer; and the second rubber layer is located between the second EVA layer and the PP honeycomb layer. In this embodiment, by arranging the first rubber layer between the first EVA layer and the PP honeycomb layer, and the second rubber layer between the second EVA layer and the PP honeycomb layer, a better shock-absorbing effect can also be obtained, so as to effectively reduce the noise.

In some embodiments, the handle includes an inner shaft made of a wooden or metal material and an outer sleeve made of a rubber material, wherein the inner shaft is fixedly connected to one side of the racket main body, and the outer sleeve sleeves the inner shaft. In this embodiment, the outer sleeve made of the rubber material can be provided to effectively improve a buffering effect between the hand and the handle, thereby improving the grip comfort.

In some embodiments, the outer sleeve is fixedly connected to the first EVA layer and the second EVA layer, which are located on one side of the racket main body, along one end of the outer sleeve in an axial direction. In some embodiments, since the outer sleeve is fixedly connected to the first EVA layer and the second EVA layer, which are located on one side of the racket main body, along one end of the outer sleeve in the axial direction, a reaction force of the first EVA layer and the second EVA layer to hit the ball can be transmitted to the human body through the outer sleeve and then to the ground, which can further reduce the noise.

In some embodiments, a radial dimension of each of both axial ends of the handle is greater than a radial dimension of a middle part. In this embodiment, since the radial dimension of each of both axial ends of the handle is greater than the radial dimension of the middle part, the handle can be well held and is not easy to escape.

In a second aspect, an embodiment of the present application provides a pickleball racket. The pickleball racket includes a racket main body and a handle, wherein the handle is connected to one side of the racket main body; the racket main body includes an upper panel, a lower panel, and a first EVA layer, a first PP honeycomb layer, a second EVA layer, a second PP honeycomb layer and a third EVA layer located between the upper panel and the lower panel; the first EVA layer, the first PP honeycomb layer, the second EVA layer, the second PP honeycomb layer and the third EVA layer are successively arranged in a stacked manner; and the first PP honeycomb layer and the second PP honeycomb layer each have a honeycomb slot structure. In this embodiment, the EVA material has a good buffering performance, so the first EVA layer, the second EVA layer and the third EVA layer are used to improve a buffering effect and shock resistance of the racket, and can absorb and reduce the vibration and impact generated in the event of collision of the racket with the ball, thereby greatly reducing the noise, and also reducing a force on the hand, and improving a shock-absorbing effect of the racket. The PP honeycomb layer is a key component of the racket main body. The design of the honeycomb slot structure of the PP honeycomb layer can also reduce the weight of the racket, making the racket lighter and easier to control. Therefore, the pickleball racket in this embodiment has a better shock-absorbing effect, greatly reduced noise, and light weight, and is easy to control.

In addition, since the first PP honeycomb layer is located between the first EVA layer and the second EVA layer, and the second PP honeycomb layer is located between the second EVA layer and the third EVA layer, i.e., one PP honeycomb layer is provided between every two EVA layers, the impact force and vibration generated in the course of hitting the ball can be effectively dispersed to avoid structural deformation or cracking, such that the racket is more durable.

In some embodiments, the upper panel includes a first carbon fiber layer and a first glass fiber layer, the lower panel includes a second carbon fiber layer and a second glass fiber layer, wherein the first glass fiber layer and the second glass fiber layer are located between the first carbon fiber layer and the second carbon fiber layer. In this embodiment, due to high strength and rigidity of the carbon fiber material, the first carbon fiber layer and the second carbon fiber layer can be provided to improve the stability and durability of the racket. Since the glass fiber material has good elasticity and toughness, the first glass fiber layer and the second glass fiber layer are used to increase the elasticity and strength of the racket, and can absorb and disperse an impact force generated in the course of hitting the ball, reduce the degree of vibration transmission to the hand, and improve a shock-absorbing effect of the racket.

In some embodiments, the hardness of the first EVA layer is different from that of the second EVA layer. Since the hardness of the first EVA layer is different from that of the second EVA layer, a better shock-absorbing effect can be obtained to effectively reduce the noise.

In some embodiments, the thickness and hardness of the first carbon fiber layer are the same as those of the second carbon fiber layer; the thickness and hardness of the first glass fiber layer are consistent with those of the second glass fiber layer; and the thickness and hardness of the first PP honeycomb layer are consistent with those of the second PP honeycomb layer. In this embodiment, since the thickness and hardness of the first carbon fiber layer are the same as those of the second carbon fiber layer, and the thickness and hardness of the first glass fiber layer are consistent with those of the second glass fiber layer, the pickleball racket in this embodiment can have good effects both in forehand and backhand hitting, and also have good shock-absorbing and noise-reducing effects.

In some embodiments, the thickness of the first EVA layer is less than that of the third EVA layer. In this embodiment, since the thickness of the first EVA layer is less than that of the third EVA layer, there are two different slight differences when the pickleball racket in this embodiment hits the ball with its front surface and back surface. In the case of hitting the ball with the front surface, the first EVA layer is mainly provided to take effect; and in the case of hitting the ball with the back surface, the third EVA layer is mainly provided to play a role. The noise in the course of hitting the ball with the front surface is higher than that in the course of hitting the ball with the back surface. However, the elasticity of hitting the ball with the front surface is better than that of hitting the ball with the back surface, so the pickleball racket in this embodiment can provide two hitting effects for the user to select, thereby enriching the user's experience.

In some embodiments, a sum of the thickness of the first PP honeycomb layer and the thickness of the second PP honeycomb layer is greater than a sum of the thickness of the first EVA layer, the thickness of the second EVA layer, and the thickness of the third EVA layer. In this embodiment, since the total thickness of the PP honeycomb layers is greater than that of the EVA layers, the elasticity to the ball can be guaranteed to be within a required range, without being affected by the EVA layers.

In some embodiments, the thickness of the first EVA layer is greater than that of the second EVA layer. In addition, the second EVA layer is less thick and thinner than the first EVA layer, which may reduce the noise generated in the course of hitting the ball. When the racket collides with the ball, the first EVA layer can absorb and buffer the vibration, while the thinner second EVA layer can restore its shape more quickly, and reduce the duration and intensity of the vibration, thereby reducing the generation of noise.

In some embodiments, the handle includes an inner shaft made of a wooden or metal material and an outer sleeve made of a rubber material, wherein the inner shaft is fixedly connected to one side of the racket main body, and the outer sleeve sleeves the inner shaft. In this embodiment, the outer sleeve made of the rubber material can be provided to effectively improve a buffering effect between the hand and the handle, thereby improving the grip comfort.

In some embodiments, the outer sleeve is fixedly connected to the first EVA layer and the third EVA layer, which are located on one side of the racket main body, along one end of the outer sleeve in an axial direction. In this embodiment, since the outer sleeve is fixedly connected to the first EVA layer and the third EVA layer, which are located on one side of the racket main body, along one end of the outer sleeve in the axial direction, a reaction force of the first EVA layer and the third EVA layer to hit the ball can be transmitted to the human body through the outer sleeve and then to the ground, which can further reduce the noise.

In some embodiments, a radial dimension of each of both axial ends of the handle is greater than a radial dimension of a middle part. In this embodiment, since the radial dimension of each of both axial ends of the handle is greater than the radial dimension of the middle part, the handle can be well held and is not easy to escape.

### BRIEF DESCRIPTION OF DRAWINGS

In order to more clearly illustrate the technical solutions in the embodiments of the present application or in the prior art, the accompanying drawings required to be used in the description of the embodiments or the prior art are described below briefly.

FIG. 1 is a schematic structural diagram of a pickleball racket as provided by an embodiment of the present application;

FIG. 2 is a schematic diagram of an exploded structure of the pickleball racket in FIG. 1;

FIG. 3 is a sectional view of the pickleball racket in FIG. 1;

FIG. 4 is a locally enlarged schematic diagram at Part A in FIG. 3;

FIG. 5 is a locally enlarged schematic diagram at Part B in FIG. 1;

FIG. 6 is a schematic structural diagram of a pickleball racket as provided by an embodiment of the present application;

FIG. 7 is a schematic diagram of an exploded structure of the pickleball racket in FIG. 6;

FIG. 8 is a sectional view of the pickleball racket in FIG. 6;

FIG. 9 is a locally enlarged schematic diagram at Part A in FIG. 8; and

FIG. 10 is a locally enlarged schematic diagram at Part B in FIG. 6.

### DETAILED DESCRIPTION OF THE EMBODIMENTS

Firstly, part of terms related to the embodiments of the present application are described below.

The terms “first”, “second”, “third”, “fourth” and the like in the description and claims, as well as the above-mentioned drawings, of the present application are configured to distinguish similar objects, but not necessarily used to describe a specific order or precedence order. It should be understood that data used in this way may be interchanged where appropriate so that the embodiments of the present application described herein can be implemented in a sequence other than those illustrated or described herein. Furthermore, the terms “including” and “having” and any variants thereof are intended to cover non-exclusive inclusions. For example, a process, method, system, product, or device that includes a series of steps or units is not necessarily limited to those steps or units that are clearly listed, but may include other steps or units that are not clearly listed or are inherent to such processes, methods, products, or devices.

The terms “vertical”, “parallel” and the like are described in the present description.

Vertical: the term “vertical” defined in the present application is not limited to a relationship of absolute vertical intersection (an included angle is 90 degrees), allowing a relationship of non-absolute vertical intersection brought by influences of an assembly tolerance, a design tolerance and structural flatness and other factors, and allowing relationships that can be understood as vertical relationships in the presence of an error within a small angle range, e.g., within an assembly error range of 80 degrees to 100 degrees.

Parallel: the term “parallel” defined in the present application is not limited to absolute parallelism, and the definition of this parallelism may be understood as basic parallelism, allowing cases of non-absolute parallelism brought by influences of an assembly tolerance, a design tolerance and structural flatness and other factors, wherein these cases will lead to non-absolute parallelism between a sliding fit part and a first gate layer, but these case may also defined as parallelism in the present application.

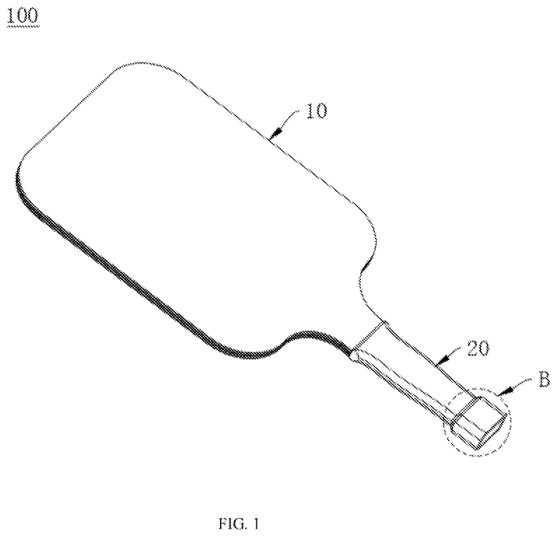

FIG. 1 to FIG. 5 show a pickleball racket 100 as provided by Embodiment I of the present application.

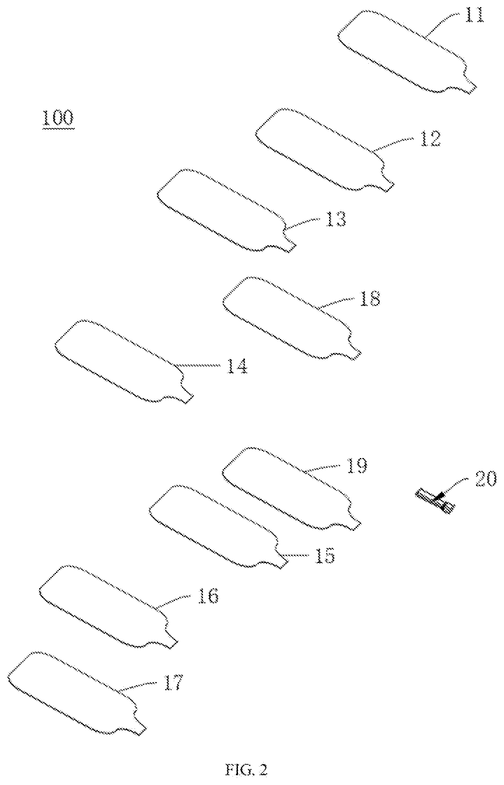

FIG. 1 is a schematic structural diagram of a pickleball racket 100 as provided by an embodiment of the present application; and FIG. 2 is a schematic diagram of an exploded structure of the pickleball racket 100 in FIG. 1.

Referring to FIG. 1 and FIG. 2, an embodiment of the present application provides a pickleball racket 100. The pickleball racket 100 includes a racket main body 10 and a handle 20. The handle 20 is connected to one side of the racket main body 10. The racket main body 10 includes a carbon fiber layer, a glass fiber layer, an EVA layer and a PP honeycomb layer, which are arranged in a stacked manner. The PP honeycomb layer has a honeycomb slot structure.

The carbon fiber layer is made of a carbon fiber material, the glass fiber layer is made of glass fiber, and the PP honeycomb layer 14 is made of a PP material. It may be understood that the carbon fiber layer, the glass fiber layer and the PP honeycomb layer 14 all belong to layer structures used in the prior art, and will not be repeated here.

In this embodiment, due to high strength and rigidity of the carbon fiber material, the carbon fiber layer can be provided to improve the stability and durability of the racket. A glass fiber material has good elasticity and toughness, so the glass fiber layer is used to increase the elasticity and strength of the racket, and can absorb and disperse an impact force generated in the course of hitting a ball, reduce the degree of vibration transmission to the hand, and improve a shock-absorbing effect of the racket. An EVA material has a good buffering performance, so the EVA layer is used to increase a buffering effect and shock resistance of the racket, and can absorb and reduce the vibration and impact generated in the event of collision of the racket with a ball, thereby greatly reducing the noise, and also reducing a force on the hand, and improving a shock-absorbing effect of the racket. The PP honeycomb layer 14 is a key component of the racket main body 10. The design of the honeycomb slot structure of the PP honeycomb layer 14 can also reduce the weight of the racket, making the racket lighter and easier to control. Therefore, the pickleball racket 100 in this embodiment has a better shock-absorbing effect, greatly reduced noise, and light weight, and is easy to control.

In some implementations, the carbon fiber layer includes a first carbon fiber layer 11 and a second carbon fiber layer 17. The glass fiber layer includes a first glass fiber layer 12 and a second glass fiber layer 16. The EVA layer includes a first EVA layer 13 and a second EVA layer 15. The first carbon fiber layer 11, the first glass fiber layer 12, the first EVA layer 13, the PP honeycomb layer 14, the second EVA layer 15, the second glass fiber layer 16 and the second carbon fiber layer 17 are successively arranged in a stacked manner. In this embodiment, since the first carbon fiber layer 11, the first glass fiber layer 12, the first EVA layer 13, the PP honeycomb layer 14, the second EVA layer 15, the second glass fiber layer 16 and the second carbon fiber layer 17 are successively arranged in a stacked manner, the effects of the respective layers can be taken effectively, and a better hitting effect can be acquired.

It should be noted that the first carbon fiber layer 11 and the second carbon fiber layer 17 are made of a carbon fiber material, the first glass fiber layer 12 and the second glass fiber layer 16 are made of glass fiber, and the PP honeycomb layer 14 is made of a PP material. It may be understood that the first carbon fiber layer 11, the second carbon fiber layer 17, the first glass fiber layer 12, the second glass fiber layer 16 and the PP honeycomb layer 14 all belong to layer structures used in the prior art, and will not be repeated here.

The first EVA layer 13 and the second EVA layer 15 are both made of an EVA material, specifically an ethylene-vinyl acetate copolymer material.

In some implementations, the thickness and hardness of the first carbon fiber layer 11 are the same as those of the second carbon fiber layer 17. Since the thickness and hardness of the first carbon fiber layer 11 are the same as those of the second carbon fiber layer 17, the processing and manufacturing are facilitated, and the production cost is reduced.

In some implementations, the thickness and hardness of the first glass fiber layer 12 are consistent with those of the second glass fiber layer 16. Since the thickness and hardness of the first glass fiber layer 12 are the same as those of the second glass fiber layer 16, the processing and manufacturing are facilitated, and the production cost is reduced.

In some implementations, the thickness and hardness of the first EVA layer 13 are consistent with those of the second EVA layer 15. Since the thickness and hardness of the first EVA layer 13 are the same as those of the second EVA layer 15, the processing and manufacturing are facilitated, and the production cost is reduced.

In this implementation, since the thickness and hardness of the first carbon fiber layer 11 are the same as those of the second carbon fiber layer 17, the thickness and hardness of the first glass fiber layer 12 are consistent with those of the second glass fiber layer 16, and the thickness and hardness of the first EVA layer 13 are consistent with those of the second EVA layer 15, the pickleball racket 100 in this embodiment can have good effects in forehand and backhand hitting, and also have good shock-absorbing and noise-reducing effects.

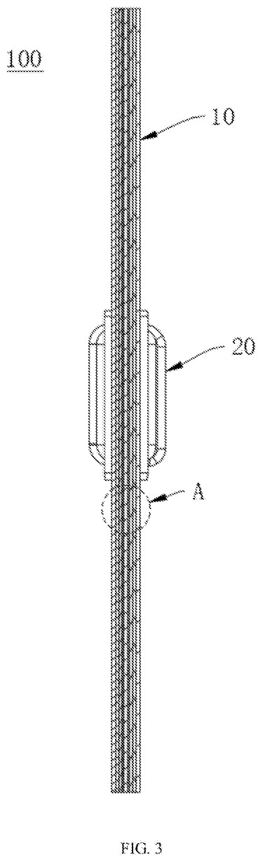

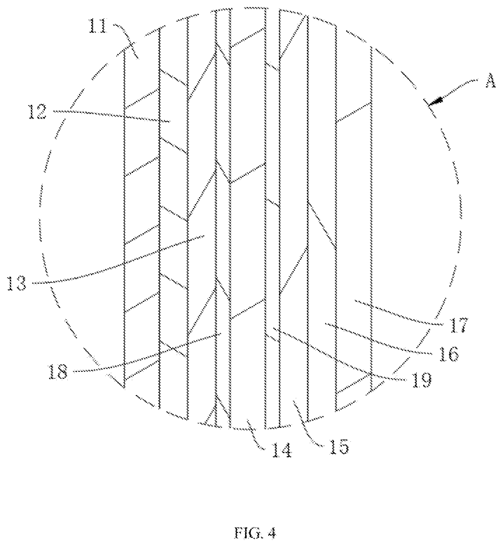

FIG. 3 is a sectional view of the pickleball racket 100 in FIG. 1; and FIG. 4 is a locally enlarged schematic diagram at Part A in FIG. 3.

Referring to FIG. 3 and FIG. 4, in some embodiments, the pickleball racket 100 further includes a third EVA layer 18. The third EVA layer 18 is located between the first EVA layer 13 and the PP honeycomb layer 14, and the thickness of the third EVA layer 18 is less than that of the first EVA layer 13. In this embodiment, since the pickleball racket 100 further includes a third EVA layer 18, and the first EVA layer 13 and the third EVA layer 18 are attached together, an assembly gap between the first EVA layer and the third EVA layer can play a better buffering role, so as to further effectively reduce the resulting noise. In addition, the third EVA layer 18 is less thick and thinner than the first EVA layer 13, which can reduce the noise generated in the course of hitting the ball. When the racket collides with the ball, the first EVA layer 13 can absorb and buffer the vibration, while the thinner third EVA layer 18 can restore its shape more quickly, and reduce the duration and intensity of the vibration, thereby reducing the generation of noise.

It may be understood that, in some other implementations, the thickness of the third EVA layer 18 may also be greater than or equal to that of the first EVA layer 13, and the elasticity will be appropriately increased at this time, but the racket may be too thick, resulting in poor controllability.

In some implementations, the hardness of the first EVA layer 13 is different from that of the third EVA layer 18. In this embodiment, since the hardness of the first EVA layer 13 is different from that of the third EVA layer 18, a better shock-absorbing effect can be obtained to effectively reduce the noise.

In some embodiments, the thickness of the PP honeycomb layer 14 is greater than a sum of the thickness of the first EVA layer 13 and the thickness of the third EVA layer 18. In this embodiment, since the thickness of the PP honeycomb layer 14 is greater than the sum of the thickness of the first EVA layer 13 and the thickness of the third EVA layer 18, the elasticity to the ball can be guaranteed to be within a required range, without being affected by the EVA layers.

Of course, the thickness of the PP honeycomb layer 14 may also be set to be less than the sum of the thickness of the first EVA layer 13 and the thickness of the third EVA layer 18 according to requirements, and may be specifically set according to a specific user or scene of the pickleball racket 100.

In some embodiments, the pickleball racket 100 further includes a fourth EVA layer 19, the fourth EVA layer 19 is located between the second EVA layer 15 and the PP honeycomb layer 14, and the thickness of the fourth EVA layer 19 is less than that of the second EVA layer 15. The fourth EVA layer 19 can be provided to further reduce the noise, i.e., reduce the noise in the course of hitting with a back surface. In addition, the fourth EVA layer 19 is less thick and thinner than the first EVA layer 13, which may reduce the noise generated in the course of hitting the ball. When the racket collides with the ball, the first EVA layer 13 can absorb and buffer the vibration, while the thinner fourth EVA layer 19 can restore its shape more quickly, and reduce the duration and intensity of the vibration, thereby reducing the generation of noise.

In some embodiments, the hardness and thickness of the fourth EVA layer 19 are consistent with those of the third EVA layer. The fourth EVA layer 19 is provided such that both hitting with the front surface and hitting with the back surface of the pickleball racket 100 can effectively reduce the noise and improve the user's experience.

In some embodiments, the thickness of the PP honeycomb layer 14 is greater than a sum of the thickness of the first EVA layer 13, the thickness of the second EVA layer 15, the thickness of the third EVA layer 18, and the thickness of the fourth EVA layer 19. Since the thickness of the PP honeycomb layer 14 is greater than the sum of the thicknesses of all the EVA layers, the elasticity to the ball can be guaranteed to be within a required range, without being affected by the EVA layers.

It may be understood that, in some implementations, the thickness of the PP honeycomb layer 14 may also be less than a sum of the thickness of the first EVA layer 13, the thickness of the second EVA layer 15, the thickness of the third EVA layer 18, and the thickness of the fourth EVA layer 19.

Based on the embodiment in FIG. 2, in some other embodiments, the pickleball racket 100 further includes a first rubber layer and a second rubber layer. The first rubber layer is located between the first EVA layer 13 and the PP honeycomb layer 14. The second rubber layer is located between the second EVA layer 15 and the PP honeycomb layer 14. In this embodiment, by arranging the first rubber layer between the first EVA layer 13 and the PP honeycomb layer 14, and the second rubber layer between the second EVA layer 15 and the PP honeycomb layer 14, a better shock-absorbing effect can also be obtained, so as to effectively reduce the noise.

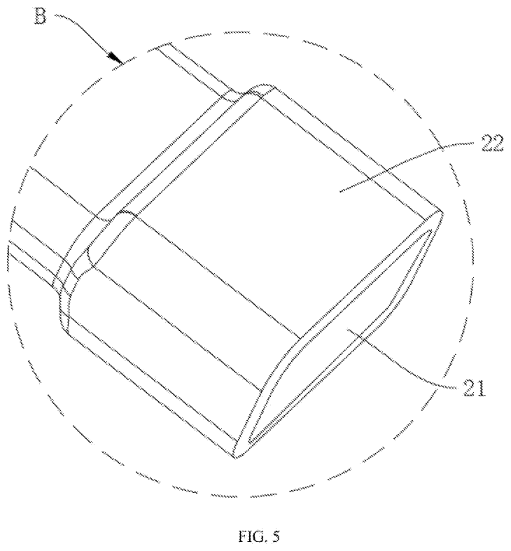

FIG. 5 is a locally enlarged schematic diagram at Part B in FIG. 1.

Referring to FIG. 1 to FIG. 5, in some embodiments, the handle 20 is of a strip-shaped structure and includes an inner shaft 21 made of a wooden or metal material and an outer sleeve 22 made of a rubber material, wherein the inner shaft 21 is fixedly connected to one side of the racket main body 10, and the outer sleeve 22 sleeves the inner shaft 21. In this embodiment, the outer sleeve 22 made of the rubber material can be provided to effectively improve a buffering effect between the hand and the handle 20, thereby improving the grip comfort.

It may be understood that the material of the inner shaft 21 of the handle 20 may also be other hard materials, such as hard plastic.

In some embodiments, the outer sleeve 22 is fixedly connected to the first EVA layer 13 and the second EVA layer 15, which are located on one side of the racket main body 10, along one end of the outer sleeve in an axial direction. In this embodiment, since the outer sleeve 22 is fixedly connected to the first EVA layer 13 and the second EVA layer 15, which are located on one side of the racket main body 10, along one end of the outer sleeve in the axial direction, a reaction force of the first EVA layer 13 and the second EVA layer 15 to hit the ball can be transmitted to the human body through the outer sleeve 22 and then to the ground, which can further reduce the noise.

In some embodiments, a radial dimension of each of both axial ends of the handle 20 is greater than a radial dimension of a middle part. In this embodiment, since the radial dimension of each of both axial ends of the handle 20 is greater than the radial dimension of the middle part, the handle can be well held and is not easy to escape.

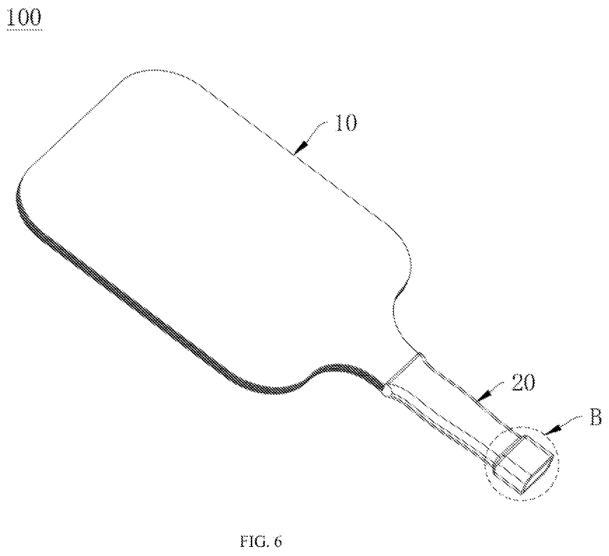

FIG. 6 to FIG. 10 show a pickleball racket 100 as provided by Embodiment II of the present application. Embodiment II has the same core concept as Embodiment I, except that a main difference between Embodiment II and Embodiment I is different arrangement and position relationship between the EVA layer and the PP honeycomb layer, but the EVA layer and the PP honeycomb layer are used both in Embodiment I and Embodiment II.

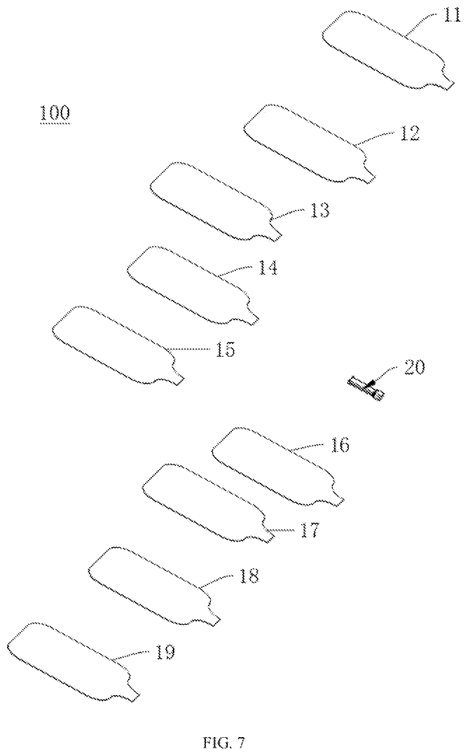

FIG. 6 is a schematic structural diagram of a pickleball racket 100 as provided by an embodiment of the present application; and FIG. 7 is a schematic diagram of an exploded structure of the pickleball racket 100 in FIG. 6.

Referring to FIG. 6 and FIG. 7, an embodiment of the present application provides a pickleball racket 100. The pickleball racket 100 includes a racket main body 10 and a handle 20. The handle 20 is connected to one side of the racket main body 10. The racket main body 10 includes an upper panel, a lower panel, and a first EVA layer 13, a first PP honeycomb layer 14, a second EVA layer 15, a second PP honeycomb layer 16 and a third EVA layer 17 located between the upper panel and the lower panel.

In some implementations, the upper panel includes a first carbon fiber layer 11 and a first glass fiber layer 12. The lower panel includes a second carbon fiber layer 19 and a second glass fiber layer 18, wherein the first glass fiber layer 12 and the second glass fiber layer 18 are located between the first carbon fiber layer 11 and the second carbon fiber layer 19.

The first carbon fiber layer 11, the first glass fiber layer 12, the first EVA layer 13, the first PP honeycomb layer 14, the second EVA layer 15, the second PP honeycomb layer 16, the third EVA layer 17, the second glass fiber layer 18 and the second carbon fiber layer 19 are successively arranged in a stacked manner, and the first PP honeycomb layer 14 and the second PP honeycomb layer 16 each have a honeycomb slot structure.

The first carbon fiber layer 11 and the second carbon fiber layer 19 are made of a carbon fiber material, the first glass fiber layer 12 and the second glass fiber layer 18 are made of glass fiber, and the first PP honeycomb layer 14 and the second PP honeycomb layer 16 are made of a PP material. It may be understood that the first carbon fiber layer 11, the second carbon fiber layer 19, the first glass fiber layer 12, the second glass fiber layer 18, the first PP honeycomb layer 14 and the second PP honeycomb layer 16 all belong to layer structures used in the prior art, and will not be repeated here.

The first EVA layer 13, the second EVA layer 15 and the second EVA layer 17 are made of an EVA material, specifically an ethylene-vinyl acetate copolymer material.

In this embodiment, due to high strength and rigidity of the carbon fiber material, the first carbon fiber layer 11 and the second carbon fiber layer 19 can be provided to improve the stability and durability of the racket. The glass fiber material has good elasticity and toughness, so the first glass fiber layer 12 and the second glass fiber layer 18 are used to increase the elasticity and strength of the racket, and can absorb and disperse an impact force generated in the course of hitting the ball, reduce the degree of vibration transmission to the hand, and improve a shock-absorbing effect of the racket. The EVA material has a good buffering performance, so the first EVA layer 13, the second EVA layer 15 and the third EVA layer 17 are used to increase a buffering effect and shock resistance of the racket, and can absorb and reduce the vibration and impact generated in the event of collision of the racket with the ball, thereby greatly reducing the noise, and also reducing a force on the hand, and improving a shock-absorbing effect of the racket. The first PP honeycomb layer 14 and the second PP honeycomb layer 16 are key components of the racket main body 10. The design of the honeycomb slot structure of the first PP honeycomb layer 14 and the second PP honeycomb layer 16 can also reduce the weight of the racket, making the racket lighter and easier to control. Therefore, the pickleball racket 100 in this embodiment has a better shock-absorbing effect, greatly reduced noise, and light weight, and is easy to control.

In addition, since the first PP honeycomb layer 14 is located between the first EVA layer 13 and the second EVA layer 15, and the second PP honeycomb layer 16 is located between the second EVA layer 15 and the third EVA layer 17, i.e., one PP honeycomb layer is provided between every two EVA layers, the impact force and vibration generated in the course of hitting the ball can be effectively dispersed to avoid structural deformation or cracking, such that the racket is more durable. Moreover, the honeycomb slot structure of the PP honeycomb layers can effectively absorb and disperse the vibration and impact force generated in the course of hitting the ball, and reduce the generation of noise. The honeycomb slot structure can reduce the transmission of vibrations, making the racket more stable during the hitting process, while reducing the transmission of sound and reducing the generation of noise.

In some implementations, the hardness of the first EVA layer 13 is different from that of the second EVA layer 15. Since the hardness of the first EVA layer 13 is different from that of the second EVA layer 15, a better shock-absorbing effect can be obtained to effectively reduce the noise.

In some implementations, the thickness and hardness of the first carbon fiber layer 11 are the same as those of the second carbon fiber layer 19. Since the thickness and hardness of the first carbon fiber layer 11 are the same as those of the second carbon fiber layer 19, the processing and manufacturing are facilitated, and the production cost is reduced.

In some implementations, the thickness and hardness of the first glass fiber layer 12 are consistent with those of the second glass fiber layer 18. Since the thickness and hardness of the first glass fiber layer 12 are the same as those of the second glass fiber layer 18, the processing and manufacturing are facilitated, and the production cost is reduced.

In this implementation, since the thickness and hardness of the first carbon fiber layer 11 are the same as those of the second carbon fiber layer 19, the thickness and hardness of the first glass fiber layer 12 are consistent with those of the second glass fiber layer 18, the pickleball racket 100 in this embodiment can have good effects both in forehand and backhand hitting, and also have good shock-absorbing and noise-reducing effects.

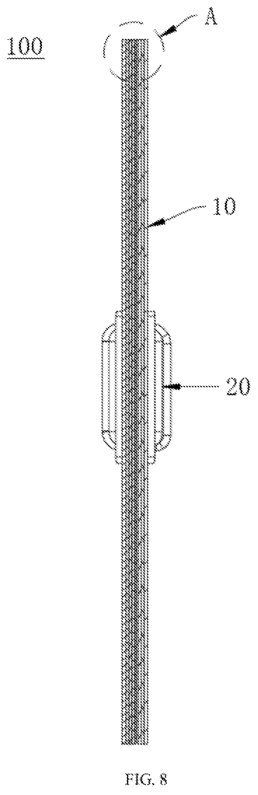

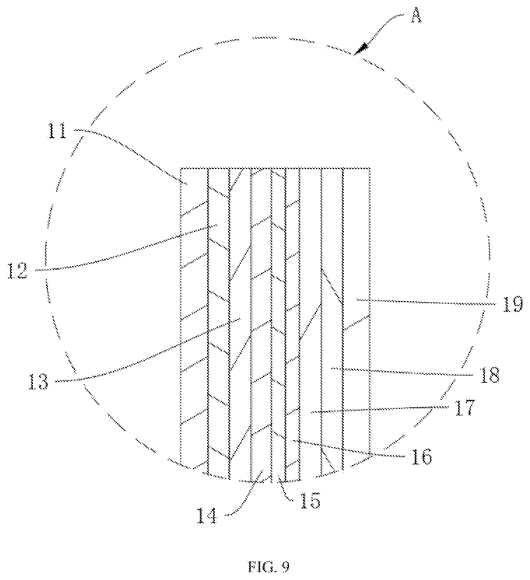

FIG. 8 is a sectional view of the pickleball racket 100 in FIG. 6; and FIG. 9 is a locally enlarged schematic diagram at Part A in FIG. 8.

Referring to FIG. 8 and FIG. 9, in some embodiments, the thickness of the first EVA layer 13 is less than that of the third EVA layer 17. In this embodiment, since the thickness of the first EVA layer 13 is less than that of the third EVA layer 17, there are two different slight differences when the pickleball racket 100 in this embodiment hits the ball with its front surface and back surface. In the case of hitting the ball with the front surface, the first EVA layer 13 is mainly provided to take effect; and in the case of hitting the ball with the back surface, the third EVA layer 17 is mainly provided to play a role. The noise in the course of hitting the ball with the front surface is higher than that in the course of hitting the ball with the back surface. However, the elasticity of hitting the ball with the front surface is better than that of hitting the ball with the back surface, so the pickleball racket 100 in this embodiment can provide two hitting effects for the user to select, thereby enriching the user's experience.

It may be understood that, in some other implementations, the thickness of the third EVA layer 13 may also be greater than or equal to that of the third EVA layer 17, and may be specifically set according to the needs of usage scenarios.

In some embodiments, a sum of the thickness of the first PP honeycomb layer 14 and the thickness of the second PP honeycomb layer 16 is greater than a sum of the thickness of the first EVA layer 13, the thickness of the second EVA layer 15, and the thickness of the third EVA layer 17. In this embodiment, since the total thickness of the PP honeycomb layers is greater than that of the EVA layers, the elasticity to the ball can be guaranteed to be within a required range, without being affected by the EVA layers.

It may be understood that, in some other implementations, a sum of the thickness of the first PP honeycomb layer 14 and the thickness of the second PP honeycomb layer 16 may also be less than a sum of the thickness of the first EVA layer 13, the thickness of the second EVA layer 15, and the thickness of the third EVA layer 17, and may be specifically set according to the needs of usage scenarios.

In some embodiments, the thickness of the first EVA layer 13 is greater than that of the second EVA layer 15. In this embodiment, the second EVA layer 15 is less thick and thinner than the first EVA layer 13, which can reduce the noise generated in the course of hitting the ball. When the racket collides with the ball, the first EVA layer 13 can absorb and buffer the vibration, while the thinner second EVA layer 15 can restore its shape more quickly, and reduce the duration and intensity of the vibration, thereby reducing the generation of noise.

It may be understood that, in some other implementations, the thickness of the first EVA layer 13 may also be less than or equal to that of the second EVA layer 15, and may be specifically set according to the needs of usage scenarios.

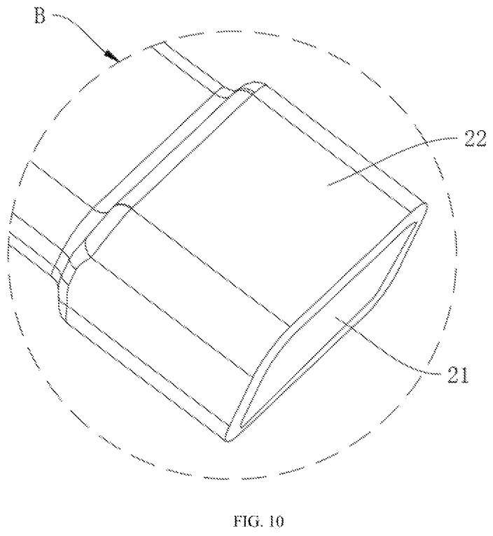

FIG. 10 is a locally enlarged schematic diagram at Part B in FIG. 6.

Referring to FIG. 6 to FIG. 10, in some embodiments, the handle 20 is of a strip-shaped structure and includes an inner shaft 21 made of a wooden or metal material and an outer sleeve 22 made of a rubber material, wherein the inner shaft 21 is fixedly connected to one side of the racket main body 10, and the outer sleeve 22 sleeves the inner shaft 21. In this embodiment, the outer sleeve 22 made of the rubber material can be provided to effectively improve a buffering effect between the hand and the handle 20, thereby improving the grip comfort.

It may be understood that the material of the inner shaft 21 of the handle 20 may also be other hard materials, such as hard plastic.

In some embodiments, the outer sleeve 22 is fixedly connected to the first EVA layer 13 and the second EVA layer 15, which are located on one side of the racket main body 10, along one end of the outer sleeve in an axial direction. In this embodiment, since the outer sleeve 22 is fixedly connected to the first EVA layer 13 and the second EVA layer 15, which are located on one side of the racket main body 10, along one end of the outer sleeve in the axial direction, a reaction force of the first EVA layer 13 and the second EVA layer 15 to hit the ball can be transmitted to the human body through the outer sleeve 22 and then to the ground, which can further reduce the noise.

In some embodiments, a radial dimension of each of both axial ends of the handle 20 is greater than a radial dimension of a middle part. In this embodiment, since the radial dimension of each of both axial ends of the handle 20 is greater than the radial dimension of the middle part, the handle can be well held and is not easy to escape.

The above are only specific embodiments of the present application, but the protection scope of the present application is not limited thereto. Within the technical scope disclosed in the present application, any change or replacement easily derived by a person skilled in the art shall fall within the protection scope of the present invention. Therefore, the protection scope of the present application should be subject to the protection scope of the appended claims.

What is claimed is:

1. A pickleball racket, comprising a racket main body and a handle, wherein the handle is connected to one side of the racket main body; the racket main body comprises a carbon fiber layer, a glass fiber layer, an EVA layer and a PP honeycomb layer, which are arranged in a stacked manner; and the PP honeycomb layer has a honeycomb slot structure.

2. The pickleball racket according to claim 1, wherein the carbon fiber layer comprises a first carbon fiber layer and a second carbon fiber layer; the glass fiber layer comprises a first glass fiber layer and a second glass fiber layer; the EVA layer comprises a first EVA layer and a second EVA layer; and
the first carbon fiber layer, the first glass fiber layer, the first EVA layer, the PP honeycomb layer, the second EVA layer, the second glass fiber layer and the second carbon fiber layer are successively arranged in a stacked manner.

3. The pickleball racket according to claim 2, further comprising a third EVA layer, wherein the third EVA layer is located between the first EVA layer and the PP honeycomb layer, and a thickness of the third EVA layer is less than that of the first EVA layer.

4. The pickleball racket according to claim 3, wherein the hardness of the first EVA layer is different from that of the third EVA layer.

5. The pickleball racket according to claim 3, further comprising a fourth EVA layer, wherein the fourth EVA layer is located between the second EVA layer and the PP honeycomb layer, and a thickness of the fourth EVA layer is less than that of the second EVA layer.

6. The pickleball racket according to claim 5, wherein the hardness and thickness of the fourth EVA layer are consistent with those of the third EVA layer.

7. The pickleball racket according to claim 2, further comprising a first rubber layer and a second rubber layer, wherein the first rubber layer is located between the first EVA layer and the PP honeycomb layer, and the second rubber layer is located between the second EVA layer and the PP honeycomb layer.

8. The pickleball racket according to claim 1, wherein the handle comprises an inner shaft made of a wooden or metal material and an outer sleeve made of a rubber material, the inner shaft is fixedly connected to one side of the racket main body, and the outer sleeve sleeves the inner shaft.

9. The pickleball racket according to claim 8, wherein the outer sleeve is fixedly connected to the first EVA layer and the second EVA layer, which are located on one side of the racket main body, along one end of the outer sleeve in an axial direction.

10. The pickleball racket according to claim 8, wherein a radial dimension of each of both axial ends of the handle is greater than a radial dimension of a middle part.

11. A pickleball racket, comprising a racket main body and a handle, wherein the handle is connected to one side of the racket main body; the racket main body comprises an upper panel, a lower panel, and a first EVA layer, a first PP honeycomb layer, a second EVA layer, a second PP honeycomb layer and a third EVA layer located between the upper panel and the lower panel; the first EVA layer, the first PP honeycomb layer, the second EVA layer, the second PP honeycomb layer and the third EVA layer are successively arranged in a stacked manner; and the first PP honeycomb layer and the second PP honeycomb layer each have a honeycomb slot structure.

12. The pickleball racket according to claim 11, wherein the upper panel comprises a first carbon fiber layer and a first glass fiber layer; the lower panel comprises a second carbon fiber layer and a second glass fiber layer; and the first glass fiber layer and the second glass fiber layer are located between the first carbon fiber layer and the second carbon fiber layer.

13. The pickleball racket according to claim 11, wherein the hardness of the first EVA layer is different from that of the second EVA layer.

14. The pickleball racket according to claim 12, wherein the thickness and hardness of the first carbon fiber layer are the same as those of the second carbon fiber layer; the thickness and hardness of the first glass fiber layer are consistent with those of the second glass fiber layer; and the thickness and hardness of the first PP honeycomb layer are consistent with those of the second PP honeycomb layer.

15. The pickleball racket according to claim 11, wherein the thickness of the first EVA layer is less than that of the third EVA layer.

16. The pickleball racket according to claim 11, wherein the thickness of the first EVA layer is greater than that of the second EVA layer.
